(19) United States
(12) Patent Application Publication
(10) Pub. No.: US 2022/0220247 A1
(43) Pub. Date: Jul. 14, 2022

(54) Composition Comprising Silylated Polymer

(71) Applicant: Huntsman International LLC, The Woodlands, TX (US)

(72) Inventors: Christopher Phanopoulos, Moorsel (BE); Ya-Mi Chuang, Lanaken (BE); Giulio Martini, Leuven (BE)

(21) Appl. No.: 17/610,185

(22) PCT Filed: May 26, 2020
(86) PCT No.: PCT/EP2020/064539

§ 371 Date: Nov. 10, 2021

(30) Foreign Application Priority Data
May 29, 2019 (EP) 19177276.3

(51) Int. Cl. C08G 18/38; C08G 18/48; C08G 18/76; C08K 5/549; C08J 3/24

(52) U.S. Cl. CPC C08G 18/3893; C08G 18/4825; C08G 18/7671; C08K 5/549; C08K 2201/019; C08G 2150/00; C08G 2170/00; C08G 2190/00; C08J 3/24

(57) ABSTRACT

The present invention relates to a liquid composition comprising at least one silylated polymer and at least one tin-free polyhedral oligomeric titanium silsesquioxane in liquid form.

The present invention relates to a composition in liquid form, which comprises at least one silylated polymer and at least one tin-free polyhedral oligomeric silsesquioxane (POSS) compound. Silylated polymer in the context of the present invention is moisture curable.

Many commercial products containing moisture curable silylated polymer composition are known and have many commercial applications, e.g. in coatings, adhesives, sealants and industrial elastomeric goods.

The curing of these moisture curable silylated polymer compositions can be performed by means of curing agents, such as organotin compounds (e.g. dibutyl tin dilaurate (DBTDL)), which have proved to be an effective curing agent. Such compounds catalyze the curing process, which comprises hydrolysis/condensation reactions of the alkoxysilane functionality of silylated polymers.

However, these organotin compounds are classified as toxic, and hence, their use should be avoided or limited in articles.

Therefore, there is a need for a tin-free curing agent, which can replace organotin compounds, and which can display at least similar performance levels compared to these compounds.

Toxicity of tin has been addressed by limiting quantities of tin in the final product, in particular by reducing tin level below 0.1 wt %.

Alternatively, other organometallic curing agents based on, e.g. Zr, Bi, Ti have been screened. Also, pH driven cure processes using amines and/or acids as curing agents have been used for silylated polymers.

However, these alternatives have not proven to be satisfactory, either tin levels are still too high from a toxicity point of view or alternative curing agents do not perform at the same level as tin. Furthermore, some alternative curing agents are known to often result in discoloring of polymer, which is not desired in the context of the present invention.

In addition, it has been observed that known tin-free POSS compounds are generally provided in solid form, which requires the use of a solvent, which is undesirable with respect to VOC compounds.

The present invention provides a liquid composition comprising at least one silylated polymer and at least one tin-free polyhedral oligomeric titanium silsesquioxane in liquid form, which is a compound of formula (I):

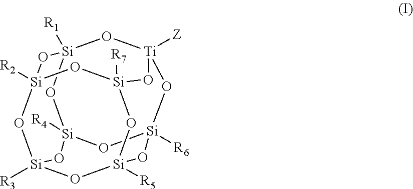

Wherein,
Z is —OH or —O—C₁₀alkyl, preferably —O—C₁₋₄ alkyl, more preferably —O-methyl or —O-ethyl;
R₁, R₂, R₃, R₄, R₅, R₆ and R₇ are independently selected from substituted or unsubstituted C₈₋₂₀ alkyl, preferably C₈₋₁₈ alkyl, more preferably C₈₋₁₅ alkyl, even more preferably C₈₋₁₃ alkyl, substituted or unsubstituted C₈₋₂₀ cycloalkyl, substituted or unsubstituted C₈₋₂₀ alkenyl, or substituted or unsubstituted C₈₋₂₀ aryl;
Or
wherein R₁ to R₇ are each substituted or unsubstituted C₈ alkyl or C₉ alkyl or C₁₀ alkyl or C₁₁ alkyl or C₁₂ alkyl or C₁₃ alkyl or C₁₄ alkyl or C₁₅ alkyl or C₁₆ alkyl or C₁₇ alkyl or C₁₈ alkyl or C₁₉ alkyl or C₂₀ alkyl or combinations thereof;
Or
Wherein at least one first radical of R₁ to R₇ is chosen from substituted or unsubstituted C₈₋₂₀ alkyl, preferably C₈₋₁₈ alkyl, more preferably C₈₋₁₅ alkyl, even more preferably C₈₋₁₃ alkyl, substituted or unsubstituted C₈₋₂₀ cycloalkyl, preferably C₈₋₁₈ cycloalkyl, more preferably C₈₋₁₅ cycloalkyl, even more preferably C₈₋₁₃ cycloalkyl, substituted or unsubstituted C₈₋₂₀ alkenyl, preferably C₈₋₁₈ alkenyl, more preferably C₈₋₁₅ alkenyl, even more preferably C₈₋₁₃ alkenyl or substituted or unsubstituted C₈₋₂₀ aryl, preferably C₈₋₁₈ aryl, more preferably C₈₋₁₅ aryl, even more preferably C₈₋₁₃ aryl, and wherein at least one second radical of R₁ to R₇, different from said at least one first radical, is selected from substituted or unsubstituted C₁₋₇ alkyl, substituted or unsubstituted C₁₋₇ cycloalkyl, substituted or unsubstituted C₁₋₇ alkenyl, substituted or unsubstituted C₁₋₇ aryl, and wherein the remaining radicals of R₁ to R₇ are independently selected from substituted or unsubstituted C₁₋₇ alkyl, substituted or unsubstituted C₁₋₇ cycloalkyl, substituted or unsubstituted C₁₋₇ alkenyl, or substituted or unsubstituted C₁₋₇ aryl, substituted or unsubstituted C₈₋₂₀ alkyl, substituted or unsubstituted C₈₋₂₀ cycloalkyl, substituted or unsubstituted C₈₋₂₀ alkenyl, or substituted or unsubstituted C₈₋₂₀ Aryl.

It has been observed that the composition of the present invention is advantageous for the user, since said at least one tin-free polyhedral oligomeric titanium silsesquioxane in liquid form has a structure which leads to a final compound, which is provided in liquid form. This means that the use of a solvent is no longer needed, which makes the invention simpler and less complex compared with known compounds from the prior art. In addition, haziness and VOC in the final composition are highly reduced compared with POSS compounds dissolved in a solvent.

In the context of the invention, the curing agent (liquid POSS compound) has chemical structure, which makes possible to get rid of the use of a solvent. Solubilization of the curing agent is no longer a limiting feature.

In some embodiments, R₁ to R₇ are independently selected from substituted or unsubstituted C₈₋₂₀ alkyl, preferably C₈₋₁₈ alkyl, more preferably C₈₋₁₅ alkyl, even more preferably C₈₋₁₃ alkyl, substituted or unsubstituted C₈₋₂₀ cycloalkyl, preferably C₈₋₁₈ cycloalkyl, more preferably C₈₋₁₅ cycloalkyl, even more preferably C₈₋₁₃ cycloalkyl, substituted or unsubstituted C₈₋₂₀ alkenyl, preferably C₈₋₁₈ alkenyl, more preferably C₈₋₁₅ alkenyl, even more preferably C₈₋₁₃ alkenyl, or substituted or unsubstituted C₈₋₂₀ aryl, preferably C₈₋₁₈ aryl, more preferably C₈₋₁₅ aryl, even more preferably C₈₋₁₃ aryl, when Z is —OH or —O—C₁₋₄ alkyl.

According to a preferred embodiment, R₁ to R₇ are each substituted or unsubstituted C₈ alkyl or C₉ alkyl or C₁₀ alkyl or C₁₁ alkyl or C₁₂ alkyl or C₁₃ alkyl or C₁₄ alkyl or C₁₅ alkyl or C₁₆ alkyl or C₁₇ alkyl or C₁₈ alkyl or C₁₉ alkyl or C₂₀ alkyl or combinations thereof, when Z is —OH or —O—C₁₋₄ alkyl. Preferably, the recited alkyl radical can be substituted by cycloalkyl, alkenyl, aryl radicals or combinations thereof, when Z is —OH or —O—C₁₋₄ alkyl.

Advantageously, at least 2 radicals, preferably at least 3 radicals, more preferably at least 4 radicals, even more preferably at least 5 radicals, advantageously at least 6 radicals from R₁ to R₇ are selected from substituted or unsubstituted C₈₋₂₀ alkyl, preferably C₈₋₁₈ alkyl, more preferably C₈₋₁₅ alkyl, even more preferably C₈₋₁₃ alkyl, C₈₋₂₀ cycloalkyl, substituted or unsubstituted C₈₋₂₀ alkenyl, or substituted or unsubstituted C₈₋₂₀ aryl, and wherein the remaining ones are independently selected from substituted or unsubstituted C₁₋₇ alkyl, C₁₋₇ cycloalkyl, substituted or unsubstituted C₁₋₇ alkenyl, or substituted or unsubstituted C₁₋₇ aryl.

More advantageously, at least 2 radicals, preferably at least 3 radicals, more preferably at least 4 radicals, even more preferably at least 5 radicals, advantageously at least 6 radicals from R₁ to R₇ are each C₈ alkyl or C₉ alkyl or C₁₀ alkyl or C₁₁ alkyl or C₁₂ alkyl or C₁₃ alkyl or C₁₄ alkyl or C₁₅ alkyl or C₁₆ alkyl or C₁₇ alkyl or C₁₈ alkyl or C₁₉ alkyl or C₂₀ alkyl, and wherein the remaining ones are independently selected from substituted or unsubstituted C₁₋₇ alkyl, C₁₋₇ cycloalkyl, substituted or unsubstituted C₁₋₇ alkenyl, or substituted or unsubstituted C₁₋₇ aryl.

According to a particularly preferred embodiment, wherein at least 20% in mole of R₁ to R₇ are individually selected from the list consisting of substituted or unsubstituted C₈₋₂₀ alkyl, preferably C₈₋₁₈ alkyl, more preferably C₈₋₁₅ alkyl, even more preferably C₈₋₁₃ alkyl, C₈₋₂₀ cycloalkyl, substituted or unsubstituted C₈₋₂₀ alkenyl, or substituted or unsubstituted C₈₋₂₀ aryl, preferably when Z is —OH or O—C₁₋₄ alkyl, preferably O-methyl or O-ethyl.

In an advantageous embodiment, wherein at least 50% in mole of R₁ to R₇ are individually selected from the list consisting of substituted or unsubstituted C₈₋₂₀ alkyl, preferably C₈₋₁₈ alkyl, more preferably C₈₋₁₅ alkyl, even more preferably C₈₋₁₃ alkyl, C₈₋₂₀ cycloalkyl, substituted or unsubstituted C₈₋₂₀ alkenyl, or substituted or unsubstituted C₈₋₂₀ aryl, preferably when Z is —OH or O—C₁₋₄ alkyl, preferably O-methyl or O-ethyl.

In any of the above mentioned preferred embodiment, Z of formula I is —O—C₁₋₄ alkyl preferably O-methyl or O-ethyl.

Advantageously, said silylated polymer comprises a silane moiety, which is linked to at least one radical which can be O-methyl or O-ethyl, when Z is respectively, O-methyl or O-ethyl. With this embodiment, curing rate is better controlled.

According to a preferred embodiment, said at least one tin-free polyhedral oligomeric titanium silsesquioxane is in liquid form, in the absence of solvent.

Particularly, said at least one tin-free polyhedral oligomeric titanium silsesquioxane in liquid form can be further mixed with a corresponding tin-free polyhedral oligomeric titanium silsesquioxane in solid form leading to a mixture (obtained composition), wherein the solid form of the tin-free polyhedral oligomeric titanium silsesquioxane is soluble in said at least one tin-free polyhedral oligomeric titanium silsesquioxane in liquid form.

According to a particularly preferred embodiment of the present invention, when the above mixture is used in combination with the silylated polymer, in particular MS polymer, of the invention, the obtained POSS compound comprises up to 30% in mole, preferably 25% in mole of the solid POSS, in order to keep a homogeneous composition. When the composition comprises other compounds (additives, etc. . . . ), the amount of solid POSS can be increased in the final composition.

Preferably, the silylated polymer is selected from the group consisting of silylated polyether, silylated silicone and silylated polyurethanes.

In a specific embodiment, said silylated polymer comprises alkoxysilyl or silanol moieties.

In the context of the present invention, said at least one tin-free polyhedral oligomeric titanium silsesquioxane is substantially free of any added amount of solvent.

The wording “substantially free of any added amount of solvent” should be understood as meaning that said at least one tin-free polyhedral oligomeric titanium silsesquioxane has a structure which makes it liquid as such. This enables avoiding the use of any type of solvent. In particular, this means that less than 0.01 wt % of solvent is used, preferably less than 0.001 wt %, more preferably less than 0.0001 wt %, based on the total weight of said at least one tin-free polyhedral oligomeric titanium silsesquioxane.

According to a particular aspect of the invention, said silylated polymer is obtained by reaction of at least one isocyanate with at least one isocyanate reactive compound and with at least one alkoxysilane compound, preferably an aminoalkoxysilane, or silanol compound.

Preferably, the amount of said tin-free polyhedral oligomeric titanium silsesquioxane is ranging from 0.001 wt % to 5 wt %, preferably 0.01 to 2 wt %, more preferably 0.1 to 2 wt %, based on total weight of the composition.

More preferably, the composition of the present invention contains less than 0.001 wt % of tin.

The composition of the present invention can advantageously comprise one or more additives selected from the group consisting of fillers, adhesion promoters, moisture scavengers, plasticizers, UV stabilizers, thixotropic agents or combinations thereof, preferably wherein, said one or more additives is a silane. The skilled person will be aware of any other possibilities.

Other embodiments of the composition of the present invention are mentioned in the annexed claims.

The present invention also relates to a moisture curable silylated polymer composition obtainable by applying the following steps:
Providing at least one silylated polymer as defined according to any one of the preceding claims;
Mixing said at least one silylated polymer with at least one tin-free polyhedral oligomeric titanium silsesquioxane in liquid form as defined according to any one of the preceding claims.

Other embodiments of the moisture curable silylated polymer composition of the present invention are mentioned in the annexed claims.

All features mentioned for the at least one tin-free polyhedral oligomeric titanium silsesquioxane in liquid form hereinabove are also applicable to the moisture curable silylated polymer composition.

The present invention also concerns a process for manufacturing a moisture curable silylated polymer composition, which process comprises the following steps:
Adding said at least one silylated polymer composition to at least one tin-free polyhedral oligomeric titanium silsesquioxane in liquid form as defined according to the present invention;
Curing said silylated polymer composition.

Other embodiments of the process of the present invention are mentioned in the annexed claims.

All features mentioned for the at least one tin-free polyhedral oligomeric titanium silsesquioxane in liquid form hereinabove are also applicable to the process for manufacturing said moisture curable silylated polymer composition, preferably polyurethane composition. The present invention also relates to an article, which comprises the composition according to the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

The wording “substituted or unsubstituted C₈ alkyl” used in the phrase “R₁ to R₇ are each substituted or unsubstituted C₈ alkyl or C₉ alkyl or C₁₀ alkyl or C₁₁ alkyl or C₁₂ alkyl or C₁₃ alkyl or C₁₄ alkyl or C₁₅ alkyl or C₁₆ alkyl or C₁₇ alkyl or C₁₈ alkyl or C₁₉ alkyl or C₂₀ alkyl or combinations thereof” means that every recited radical in the above list can be substituted or unsubstituted. The same principle applies for cycloalkyl, alkenyl and aryl radicals.

Suitable polymers for the use in the present invention are silylated polymers. Non-limiting examples of silylated polymer can be selected from the group comprising silylated polymers, silylated silicones, silylated polyethers (MS polymers), silylated polycarbonates, silylated polyolefins, silylated polyesters, silylated polyacrylates, silylated polyvinyl acetates; and mixtures thereof and copolymers thereof.

Preferably, silylated polyether, silylated silicone and silylated polyurethanes are preferred in the context of the present invention.

In some preferred embodiment, said silylated polymer refers to a polymer that comprises one or more alkoxysilyl or silanol moieties. Alkoxysilyl or silanol containing polymers can be silane terminated, silane grafted. Preferably, silylated polymers are polymers comprising alkoxysilyl or silanol moieties.

Suitable polymers comprising alkoxysilyl or silanol moieties for the use in the present invention are selected from the group comprising polyurethanes comprising alkoxysilyl or silanol moieties; silicones comprising alkoxysilyl or silanol moieties; polyethers comprising alkoxysilyl or silanol moieties; polycarbonates comprising alkoxysilyl or silanol moieties; polyolefins comprising alkoxysilyl or silanol moieties; polyesters comprising alkoxysilyl or silanol moieties; polyacrylates comprising alkoxysilyl or silanol moieties; polyvinyl acetates comprising alkoxysilyl or silanol moieties; and mixtures thereof and copolymers thereof.

Silylation of the suitable polymers for use in the present invention can be made in any possible way known to person skilled in the art by using alkoxysilane or silanol compounds.

In an embodiment, a suitable silylated polymer is a silylated polymer, for example a polyurethane comprising alkoxysilyl or silanol moieties.

Silylated polymers are known and commercially available. Non-limiting examples of commercially available silylated polymers include SPUR materials from Momentive or Polymer ST from Evonik. In some embodiments, the silylated polymers can be prepared by contacting at least one isocyanate with one or more compounds containing isocyanate-reactive functional group and one or more alkoxysilyl or silanol compounds, in any possible order of addition.

Non-limiting examples of processes for preparing silylated polymer are described in WO 2011/161011 hereby incorporated by reference. For example, a silylated polymer can be prepared by contacting a polyisocyanate with an isocyanate reactive compound (such as a polyol, such as a polyalkyleneglycol), and subsequently silylating the mixture with an alkoxysilane.

Suitable isocyanates for use in the preparation of silylated polymer may be aromatic, cycloaliphatic, heterocyclic, araliphatic or aliphatic organic polyisocyanates. Suitable isocyanates include also polyisocyanates.

Suitable polyisocyanates for use in preparing the silylated polymer components comprise polyisocyanates of the type Ra-(NCO)x with x at least 1 and Ra being an aromatic or aliphatic group, such as diphenylmethane, toluene, dicyclohexylmethane, hexamethylene, isophorone diisocyanate or a similar polyisocyanate.

Non-limiting examples of suitable polyisocyanates that can be used in the present invention can be any organic polyisocyanate compound or mixture of organic polyisocyanate compounds, preferably wherein said compounds have at least two isocyanate groups. Non-limiting examples of organic polyisocyanates include diisocyanates, aromatic or aliphatic diisocyanates, and isocyanates of higher functionality. Non-limiting examples of organic polyisocyanates which may be used in the formulation of the present invention include aliphatic isocyanates such as hexamethylene diisocyanate, isophorone diisocyanate; and aromatic isocyanates such as diphenylmethane diisocyanate (MDI) in the form of its 2,4′, 2,2′ and 4,4′ isomers and mixtures thereof (also referred to as pure MDI), the mixtures of diphenylmethane diisocyanates (MDI) and oligomers thereof (known in the art as “crude” or polymeric MDI), m- and p-phenylene diisocyanate, tolylene-2,4- and tolylene-2,6-diisocyanate (also known as toluene diisocyanate, and referred to as TDI, such as 2,4-TDI and 2,6-TDI) in any suitable isomer mixture, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyl-diphenylmethane-4,4′-diisocyanate and diphenyl ether diisocyanate; and cycloaliphatic diisocyanates such as cyclohexane-2,4- and -2,3-diisocyanate, 1-methylcyclohexyl-2,4- and -2,6-diisocyanate and mixtures thereof and bis-(isocyanatocyclohexyl)methane (e.g. 4,4′-diisocyanatodicyclohexylmethane (H12MDI)), triisocyanates such as 2,4,6-triisocyanatotoluene and 2,4,4-triisocyanatodiphenylether, isophorone diisocyanate (IPDI), butylene diisocyanate, trimethylhexa methylene diisocyanate, isocyanatomethyl-1,8-octane diisocyanate, tetramethylxylene diisocyanate (TMXDI), 1,4-cyclohexanediisocyanate (CDI), and tolidine diisocyanate (TODI); any suitable mixture of these polyisocyanates, and any suitable mixture of one or more of these polyisocyanates with MDI in the form of its 2,4′-, 2,2′- and 4,4′-isomers and mixtures thereof (also referred to as pure MDI), the mixtures of diphenylmethane diisocyanates (MDI) and oligomers thereof (known in the art as “crude” or polymeric MDI), and reaction products of polyisocyanates (e.g. polyisocyanates as set out above, and preferably MDI-based polyisocyanates), with components containing isocyanate-reactive functional group and alkoxysilane compound such as amino alkoxysilanes to form polymeric silylated polyisocyanates or so-called silylated prepolymers. Preferably toluene diisocyanates (TDI), diphenylmethane diisocyanate (MDI)-type isocyanates, and prepolymers of these isocyanates are used. The polymeric methylene diphenyl diisocyanate can be any mixture of pure MDI (2,4′, 2,2′ and 4,4′ methylene diphenyl diisocyanate).

Prepolymeric polyisocyanates for use in the preparation of the silylated polymer can have isocyanate values from 0.5 wt % to 33 wt % by weight of the prepolymer, preferably from 0.5 wt % to 12 wt %, more preferably from 0.5 wt % to 6 wt % and most preferably from 1 wt % to 6 wt %.

Isocyanate reactive compound may be alcohols, e.g. polyols such as glycols or even relatively high molecular weight polyether polyols and polyester polyols, mercaptans, carboxylic acids such as polybasic acids, amines, polyamines, components comprising at least one alcohol group and at least one amine group, such as polyamine polyols, urea and amides.

In some preferred embodiment, the isocyanate reactive compounds are typically components including polyols such as glycols; hydroxyl terminated polyester (polyester polyols); a hydroxyl terminated polyether (polyether polyols); a hydroxyl terminated polycarbonate or mixture thereof, with one or more chain extenders, all of which are well known to those skilled in the art.

The hydroxyl terminated polyester (polyester polyols) can be generally a polyester having a number average molecular weight (Mn) of from about 500 to about 10000, desirably from about 700 to about 5000, and preferably from about 700 to about 4000, an acid number generally less than 1.3 and preferably less than 0.8. The molecular weight is determined by assay of the terminal functional groups and is related to the number average molecular weight. The hydroxyl terminated polyester can be produced by (1) an esterification reaction of one or more glycols with one or more dicarboxylic acids or anhydrides or (2) by transesterification reaction, i.e. the reaction of one or more glycols with esters of dicarboxylic acids. Mole ratios generally in excess of more than one mole of glycol to acid are preferred, so as to obtain linear chains having a preponderance of terminal hydroxyl groups. Suitable polyesters also include various lactones such as polycaprolactone typically made from caprolactone and a bifunctional initiator such as diethylene glycol. The dicarboxylic acids of the desired polyester can be aliphatic, cycloaliphatic, aromatic, or combinations thereof. Suitable dicarboxylic acids which can be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is the preferred acid. The glycols which are reacted to form a desirable polyester intermediate can be aliphatic, aromatic, or combinations thereof, and have a total of from 2 to 12 carbon atoms, and include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and the like. 1,4-Butanediol is the preferred glycol.

Hydroxyl terminated polyethers are preferably polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethylglycol) (PTMG) comprising water reacted with tetra hydrofuran (THF). Polyether polyols further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of glycerol and ethylene oxide or glycerol and propylene oxide. The various polyethers can have a number average molecular weight (Mn), as determined by assay of the terminal functional groups which is an average molecular weight, of from about 500 to about 10000, desirably from about 500 to about 5000, and preferably from about 700 to about 3000.

Hydroxyl terminated polycarbonate can be prepared by reacting a glycol with a carbonate. U.S. Pat. No. 4,131,731 is hereby incorporated by reference for its disclosure of hydroxyl terminated polycarbonates and their preparation. Such polycarbonates are preferably linear and have terminal hydroxyl groups with essential exclusion of other terminal groups. The reactants are glycols and carbonates. Suitable glycols are selected from cycloaliphatic and aliphatic diols containing 4 to 40, and preferably 4 to 12 carbon atoms, and from polyoxyalkylene glycols containing 2 to 20 alkoxy groups per molecule with each alkoxy group containing 2 to 4 carbon atoms. Suitable diols include but are not limited to aliphatic diols containing 4 to 12 carbon atoms such as butanediol-1,4, pentanediol-1,4, neopentyl glycol, hexanediol-1,6, 2,2,4-trimethylhexanedion-1,6, decanediol-1,10, hydrogenated dilinoleylglycol, hydrogenated diolelylglycol; and cycloaliphatic diols such as cyclohexanediol-1,3, dimethylolcyclohexane-1,4, cyclohexanediol-1,4, dimethylolcyclohexane-1,3, 1,4-endomethylene-2-hydroxy-5-hydroxymethyl cyclohexane, and polyalkylene glycols. The diols used in the reaction may be a single diol or a mixture of diols depending on the properties desired in the finished product. Non-limiting examples of suitable carbonates include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate and 2,4-pentylene carbonate. Also suitable are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures.

When one group is cycloaliphatic, the other can be either alkyl or aryl. On the other hand, if one group is aryl, the other can be alkyl or cycloaliphatic. Preferred examples of diarylcarbonates, which can contain 6 to 20 carbon atoms in each aryl group, are diphenylcarbonate, ditolylcarbonate and dinaphthylcarbonate.

The isocyanate reactive component can be reacted with the polyisocyanate, along with extender glycol.

Non-limiting examples of suitable extender glycols (i.e., chain extenders) include lower aliphatic or short chain glycols having from about 2 to about 10 carbon atoms and include, for instance, ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol, hydroquinone di(hydroxyethyl)ether, neopentylglycol, and the like.

Suitable silyl compounds to be used in the preparation of the silylated polymer comprise alkoxysilane compounds or silanols.

For example, a silylated polymer for use in the present composition can be prepared by mixing at least one isocyanate as described herein above, with at least one isocyanate reactive compound as described herein above, and at least one alkoxysilane and/or silanol compound.

Suitable silane or silanol compounds for use in preparing silylated polymer, preferably silylated polymer, include but are not limited to amino alkoxysilanes, alkoxysilanes, aliphatic hydroxy silanes, cycloaliphatic hydroxy silanes, aromatic hydroxy silanes, epoxy silanes, glycidoxy silanes, isocyanato silanes, anhydride silanes, aldehyde silanes, thio silanes, sulfonate silanes, phosphate silanes, caprolactam silanes, acrylate silanes, succinimide silanes, silsesquinoxane silanes, amide silanes, carbamato silanes, vinyl silanes, alkyl silanes, silanol, silanes carrying at least one hydrogen atom on the silicon and mixtures thereof. In another embodiment, Suitable silane or silanol compounds for use in preparing silylated polymer can be isocyanate silane.

In an embodiment, a suitable alkoxysilane or silanol compound, is an amino-alkoxysilane.

Suitable amino-alkoxysilanes include amino-alkoxysilanes of the following formula:

R₈—NH—R₉—(OR₁₀)₃₋ₘ(R₁₁)ₘ

wherein
R₈ is selected from H; optionally substituted C₁₋₂₄ alkyl; optionally substituted C₃₋₂₄ cycloalkyl; optionally substituted C₆₋₂₄ aryl; optionally substituted heteroaryl. Suitable substituents for the alkyl, cycloalkyl or aryl or heteroaryl groups can be selected from, for example, halogen atoms and COOH groups;
R₉ is a C₁₋₂₀ alkylene or C₆₋₂₀ arylene;
R₁₀ and R₁₁ are each independently selected from C₁₋₂₀ alkyl or C₆₋₂₀ aryl;
m is an integer selected from 0, 1 or 2.
Preferably R₉ is a C₁₋₁₂ alkylene or C₆₋₁₀ arylene, for example a C₁₋₁₀ alkylene or phenylene, for example a C₁₋₆ alkylene or phenylene, preferably a C₁ alkylene or C₃ alkylene. For example, R₉ is methylene (—CH₂)—, or propylene (CH₂)₃—.
Preferably, R₁₀ and Rn, are each independently selected from C₁₋₁₈ alkyl or C₆₋₁₈ aryl. More preferably, R₁₀ and Rn are each independently selected from C₁₋₄ alkyl or C₆₋₁₀ aryl. In the most preferred embodiment, R₁₀ and Rn are identical and are selected from methyl, ethyl, propyl, or butyl. Preferably, m is 0 or 1.

Non-limiting examples of suitable amino-alkoxysilanes are gamma-N-phenylaminopropyltrimethoxysilane, alpha-N-phenylaminomethyltrimethoxysilane, gamma-N-phenylaminopropyldimethoxymethylsilane, alpha-N-phenylaminomethyl-dimethoxymethylsilane, gamma-N-phenylaminopropyltriethoxysilane, alpha-N-phenylaminomethyltriethoxysilane, gamma-N-phenylaminopropyl-diethoxyethylsilane, alpha-N-phenylaminomethyldiethoxyethylsilane, alpha-N-butylaminomethyltrimethoxysilane, gamma-N-butylaminopropyldimethoxy methylsilane, alpha-N-butylaminomethyldimethoxymethylsilane, gamma-N-butyl aminopropyltriethoxysilane, alpha-N-butylaminomethyltriethoxysilane, gamma-N-butylaminopropyldiethoxyethylsilane, alpha-N-butylaminomethyldiethoxy ethylsilane, gamma-N-methylaminopropyltrimethoxysilane, alpha-N-methylaminomethyltrimethoxysilane, gamma-N-methylaminopropyldimethoxy methylsilane, alpha-N-methylaminomethyldimethoxymethylsilane, gamma-N-methyl aminopropyltriethoxysilane, alpha-N-methylaminomethyltriethoxysilane, gamma-N-methylaminopropyldiethoxyethylsilane, alpha-N-methylaminomethyldiethoxy ethylsilane, gamma-N-cyclohexylaminopropyltrimethoxysilane, alpha-N-cyclohexylaminomethyltrimethoxysilane, gamma-N-cyclohexylaminopropyl-dimethoxymethylsilane, alpha-N-cyclohexylaminomethyldimethoxymethylsilane, gamma-N-cyclohexylaminopropyltriethoxysilane, alpha-N-cyclohexylaminomethyl-triethoxysilane, gamma-N-cyclohexylaminopropyldiethoxyethylsilane, alpha-N-cyclohexylaminomethyldiethoxyethylsilane, gamma-aminopropyltrimethoxysilane, alpha-aminomethyltrimethoxysilane, gamma-aminopropyldimethoxymethylsilane, alpha-aminomethyldimethoxymethylsilane, gamma-aminopropyltriethoxysilane, alpha-aminomethyltriethoxysilane, gamma-aminopropyldiethoxyethylsilane, alpha-aminomethyldiethoxyethylsilane.

In preparing a silylated polymer, the polyisocyanate can be pre-reacted with the isocyanate-reactive compound, in the presence of said alkoxysilane compound to form a so-called silylated isocyanate functional prepolymer.

In an embodiment, a suitable silylated polymer is a silylated polyolefin, for example a polyolefin comprising alkoxysilyl or silanol moieties.

Silylated polyolefin are known and can be prepared as described herein below. When preparing the silylated polyolefin, the silyl group may be attached to monomers before the polymerization of the olefin; it may be attached to the polymer after polymerization, or it may be attached during some intermediate stage. Additionally, a pendant group may be attached to the monomer or the polymer and then chemically modified to create a suitable silyl group.

Non-limiting examples for preparing silylated polyolefin can be found in EP 1396511 and U.S. Pat. No. 5,994,474, hereby incorporated by reference. For example, the polyolefin can be silane grafted by melt-blending a polyolefin with a free-radical donor and silane molecules that have trialkoxysilane groups attached to ethylenically unsaturated organic portions. Suitable alkoxysilane or silanol compounds are the same as described above for the preparation of silylated polymer.

The polyolefins may be any olefin homopolymer or any copolymer of an olefin and one or more comonomers. The polyolefins may be atactic, syndiotactic or isotactic. The olefin can, for example, be ethylene, propylene, 1-butene, 1-pentene, 1-hexene, 4-methyl-1-pentene or 1-octene, but also cycloolefins such as, for example, cyclopentene, cyclohexene, cyclooctene or norbornene. The comonomer is different from the olefin and chosen such that it is suited for copolymerization with the olefin. The comonomer may also be an olefin as defined above. Comonomers may comprise but are not limited to aliphatic C₂-C₂₀ alpha-olefins. Examples of suitable aliphatic C₂-C₂₀ alpha-olefins include ethylene, propylene, 1-butene, 4-methyl-1-pentene, 1-hexene, 1-octene, 1-decene, 1-dodecene, 1-tetradecene, 1-hexadecene, 1-octadecene and 1-eicosene.

Examples of olefin copolymers include copolymers of propylene and ethylene, random copolymers of propylene and 1-butene, heterophasic copolymers of propylene and ethylene, ethylene-butene copolymers, ethylene-hexene copolymers, ethylene-octene copolymers, copolymers of ethylene and vinyl acetate (EVA), copolymers of ethylene and vinyl alcohol (EVOH).

The polyolefin, such as polyethylene, can be prepared in the presence of any catalyst known in the art. As used herein, the term “catalyst” refers to a substance that causes a change in the rate of a polymerization reaction. Examples of suitable catalysts are metallocene catalysts, chromium catalysts, and Ziegler-Natta catalysts.

In an embodiment, a suitable silylated polymer is a silylated polyester, for example, a polyester comprising alkoxysilyl or silanol moieties.

Silylated polyesters are known. Non-limiting examples of suitable processes for preparing silylated polyesters comprise processes as described in WO 2010/0136511. The process can comprise the step of silylating a polyester with a alkoxysilane or silanol compounds. Suitable alkoxysilane or silanol compounds are the same as described above for the preparation of silylated polymer.

For example, a silylated polyester can be prepared by contacting a polyester with diisodecylphthalate, and subsequently reacting the mixture with an alkoxysilane such as an isocyanatealkyltrialkoxysilane in the presence of a catalyst. Suitable alkoxysilane or silanol compounds are the same as described above for the preparation of silylated polymer

Polyesters that may be used comprise an ester structure —C(═O)O—. Non-limiting examples of suitable polyesters can comprise the following chemical structure as monomer unit [—C(═O)—C6H4-C(═O)O—(CH₂—CH₂)n-O—], wherein n is an integer from 1 to 10, with preferred values being 1 or 2. Specific examples of such suitable polyesters are polyethylene terephthalate (PET) and polybutylene terephthalate (PBT). Further non-limiting examples of suitable polyesters (and methods for producing them) comprise but are not limited to polyglycolide or polyglycolic acid (PGA) which can be produced by polycondensation of glycolic acid; polylactic acid (PLA) which can be produced by ring-opening polymerization of lactide or directly from lactic acid; poly(3-hydroxybutyrate-co-3-hydroxyvalerate) (PHBV) which can be produced by copolymerization of 3-hydroxybutanoic acid and 3-hydroxypentanoic acid, butyrolactone and valerolactone (oligomeric aluminoxane as a catalyst); polyethylene terephthalate (PET) which can be produced by polycondensation of terephthalic acid with ethylene glycol; polybutylene terephthalate (PBT) which can be produced by polycondensation of terephthalic acid with 1,4-butanediol; polytrimethylene terephthalate (PTT) which can be produced by polycondensation of terephthalic acid with 1,3-propanediol; polyethylene naphthalate (PEN) which can be produced by polycondensation of at least one naphthalene dicarboxylic acid with ethylene glycol; and vectran which can be produced by polycondensation of 4-hydroxybenzoic acid and 6-hydroxynaphthalene-2-carboxylic acid.

In an embodiment, a suitable silylated polymer is a silylated polycarbonate, for example, a polycarbonate comprising alkoxysilyl or silanol moieties.

The process can comprise the step of silylating a polycarbonate with a alkoxysilane or silanol compounds. Suitable alkoxysilane or silanol compounds are the same as described above for the preparation of silylated polymer. Polycarbonates that may be used have a carbonate groups (—O(C═O)—O—).

In an embodiment, a suitable silylated polymer is a silylated polyether, for example, a polyether comprising alkoxysilyl or silanol moieties.

Suitable polyethers are known. Non-limiting example of processes for preparing silylated polyethers can be found in WO 2011075254 hereby incorporated by reference. Suitable alkoxysilane or silanol compounds are the same as described above for the preparation of silylated polymer. For example, suitable silylated polyether can be prepared by reacting a polyether with an alkoxysilane. For example, a silylated polyether can be obtained by reacting a polyether comprising OH moieties with an isocyanatoalkoxysilane. Suitable polyether comprising OH moieties can be mixtures of different alkoxylation products of polyols. Preferred polyols include those in which polymerized propylene oxide units and/or polymerized ethylene oxide units are present. These units may be arranged in statistical distribution, in the form of polyethylene oxide blocks within the chains and/or terminally. The polyether can have an average nominal functionality of 1-6, more preferably a functionality of 1-4, most preferably a functionality of 1 or 2. The term “average nominal functionality” is used herein to indicate the number average functionality (number of functional groups per molecule) of the polyether on the assumption that this is the number average functionality of the initiator(s) used in their preparation, although in practice it will often be somewhat less because of some terminal unsaturation. As used herein, the term “average” refers to number average unless indicated otherwise. Preferably, the functional groups are alkoxysilyl or silanol reactive functional groups (i.e. groups that are reactive with alkoxysilane or silanol compounds). Non-limiting examples of alkoxysilyl or silanol reactive groups can be selected from the group comprising hydroxyl, amino, and thiol. Non-limiting examples of suitable polyethers include the products obtained by the polymerization of ethylene oxide, including products obtained by the copolymerization of ethylene oxide with another cyclic oxide, for example propylene oxide, for example in the presence of an initiator compound, preferably in the presence of one or more polyfunctional initiators. Suitable initiator compounds contain a plurality of active hydrogen atoms and comprise water and low molecular weight polyethers, for example, ethylene glycol, propylene glycol, diethylene glycol, dipropylene glycol, cyclohexane dimethanol, resorcinol, bisphenol A, glycerol, trimethylolopropane, 1,2,6-hexantriol, pentaerythritol and the like. Mixtures of initiators and/or cyclic oxide may be used. Suitable polyethers include poly(oxyethylene oxypropylene) diols and/or triols obtained by the sequential addition of propylene and ethylene oxides to di- or trifunctional initiators, as fully described in the prior art. Mixtures of said diols and triols are also useful. Preferred are monools and diols. The polyether can be selected from the group comprising polyethylene glycol, polyethylene glycol monomethyl ether, polyethylene glycol monoethyl ether, polyethylene glycol monopropyl ether, polyethylene glycol monoisopropyl ether, polyethylene glycol monobutyl ether, polyethylene glycol monopentyl ether, polyethylene glycol monohexyl ether, polyethylene glycol monophenyl ether, polyethylene glycol monobenzyl ether and mixtures thereof. According to some embodiments, the polyether can have an average molecular weight Mw of from 62 to 40000, for example from 100 to 20000, for example from 200 to 10000, for example from 400 to 6000.

In an embodiment, a suitable silylated polymer is a silylated polyvinylacetate, for example, a polyvinylacetate comprising alkoxysilyl or silanol moieties.

The silylated polyvinylacetates can be prepared by silylating a polyvinylacetate using alkoxysilane or silanol compounds. Suitable alkoxysilane or silanol compounds are the same as described above for the preparation of silylated polymer.

Suitable polyvinylacetates can have a —(C₄H₆O₂)— as monomer unit. Suitable polyvinyl acetate includes polyvinyl esters having the following general formula, as a monomer unit:

wherein R is an C₁₋₆ alkyl or a C₆₋₁₀ aryl, such as methyl, ethyl, or phenyl. Polyvinyl acetate can be prepared by polymerization of vinyl acetate monomer (free radical vinyl polymerization of the monomer vinyl acetate). Vinyl acetate can also be polymerized with other monomers to prepare copolymers such as ethylene-vinyl acetate (EVA), vinyl acetate-acrylic acid (VA/AA), polyvinyl chloride acetate (PVCA), and polyvinylpyrrolidone. Both homo- and copolymers of vinylacetate may also be used.

In an embodiment, a suitable silylated polymer is a silylated polyacrylate, for example, a polyacrylate comprising alkoxysilyl or silanol moieties.

Silylated polyacrylates are known and can be prepared as described, for example, in DE 102004055450 or U.S. Pat. No. 4,333,867, hereby incorporated by reference. Suitable alkoxysilane or silanol compounds are the same as described above for the preparation of silylated polymer. For example, a silylated polyacrylate can be prepared by mixing styrene/ethyl acrylate/acrylic acid copolymer, and reacting the mixture with an alkoxysilane such as a (meth)acryloxyalkylalkoxy silane, in the presence of styrene and acrylic acid.

Polyacrylates can be prepared by polymerizing acrylic monomers. Suitable acrylic monomers include acrylic acid, derivatives of acrylic acid, such as methyl methacrylate in which one vinyl hydrogen and the carboxylic acid hydrogen are both replaced by methyl groups and acrylonitrile in which the carboxylic acid group is replaced by the related nitrile group. Non-limiting examples of suitable acrylate monomers include methacrylates, ethyl acrylate, 2-chloroethyl vinyl ether, 2-ethylhexyl acrylate, hydroxyethyl methacrylate, butyl acrylate, and butyl methacrylate.

In an embodiment, a suitable silylated polymer is a silylated silicone, for example, a silicone comprising alkoxysilyl or silanol moieties.

Silylated silicones are known. Non-limiting examples of process for preparing said silylated silicon can be found in WO 2003/018704 and DE 102008054434. Silylated silicone can be prepared by mixing a polysiloxane with a silane compound. For example, suitable silylated silicone can be prepared by contacting α-ω-bisaminopropylpolydimethoxysiloxane, with isophorone diisocyanate and isocyanatopropyltrimethoxysilane. Suitable silicones include polysiloxanes (polymerized siloxanes). Suitable silicones comprise mixed inorganic-organic polymers with the chemical formula [R₂SiO]ₙ, where R is an organic group such as C₁₋₆ alkyl or C₆₋₁₀ aryl such as methyl, ethyl, or phenyl. The organic side groups R can be used to link two or more of these —Si—O— backbones together. By varying the Si O— chain lengths, side groups, and crosslinking, silicones can be synthesized with a wide variety of properties and compositions.

The composition of the present invention may further comprise one or more silanes. Suitable silanes can be selected from those described hereinabove for preparing the silylated polymers, such as amino silanes, alkoxysilanes, aliphatic hydroxy silanes, cycloaliphatic hydroxy silanes, aromatic hydroxy silanes, epoxy silanes, glycidoxy silanes, isocyanato silanes, anhydride silanes, aldehyde silanes, thio silanes, sulfonate silanes, phosphate silanes, caprolactam silanes, acrylate silanes, succinimide silanes, silsesquinoxane silanes, amide silanes, carbamato silanes, vinyl silanes, alkyl silanes, silanol, and silanes carrying at least one hydrogen atom on the silicon and mixtures thereof.

The composition of the present invention may comprise one or more additives. In some embodiments, said one or more additives may be selected from the group comprising fillers, adhesion promoters, moisture scavengers, plasticizers, UV stabilizers, thixotropic agents or combinations thereof. They can preferably be present in an amount ranging from 1 to 70 wt % with respect to the total weight of the composition.

The additive may be an adhesion promoter or a moisture scavenger.

Other additives may be used in the formulation of this invention. Additives such as catalysts, stabilizers, lubricants, colorants, antioxidants, antiozonates, light stabilizers, UV stabilizers and the like may be used in amounts of from 0 to 5 wt % of the composition, preferably from 0 to 2 wt %.

The composition may also comprise non-fire-retardant mineral fillers such as certain oxides, carbonates, silicates, borates, stannates, mixed oxide hydroxides, oxide hydroxide carbonates, hydroxide silicates, or hydroxide borates, or a mixture of these substances. By way of example, use may be made of calcium oxide, aluminum oxide, manganese oxide, tin oxide, boehmite, dihydrotalcite, hydrocalumite, or calcium carbonate. Preferred compounds are silicates and hydroxide silicates. These fillers are usually added in amounts of between 1 to 50% by weight based on the formulation, preferably between 1 and 30% by weight.

Preferably none of said abovementioned additives contains tin so that the composition of the present invention is substantially tin-free, i.e. has a tin content of less then 0.001 wt %.

The present invention also encompasses the use of the at least one tin-free polyhedral oligomeric titanium silsesquioxane of the present invention, for curing a composition comprising at least one silylated polymer. Suitable silylated polymers have been described above.

Furthermore, the present invention encompasses a process of curing a composition, which process comprises the step of contacting at least one silylated polymer with at least one tin-free polyhedral oligomeric titanium silsesquioxane according to the present invention. The present invention also encompasses a process of curing a composition comprising a silylated polymer, said process comprising the step of contacting the silylated polymer with at least one POSS compound (as set out above). The present invention also encompasses a process of curing a silylated polymer comprising the step of contacting a silylated polymer with at least one POSS (as set out above), thereby curing said silylated polymer by moisture ingress.

In an embodiment, said process comprises the step of contacting at least one neat or formulated silylated polymer with at least one tin-free polyhedral oligomeric titanium silsesquioxane in the presence of moisture; thereby obtaining a cured silylated polymer. In some embodiments, said process comprises the steps of: preparing at least one silylated polymer forming mixture; and contacting said mixture with one or more POSS compound as described herein before. In an embodiment, said silylated polymer forming mixture, comprises at least one isocyanate, and one or more components containing isocyanate-reactive functional group and one or more alkoxysilane or silanol compounds. In an embodiment, the process is performed by first reacting said silylated polymer forming mixture thereby obtaining a silylated polymer and then contacting/mixing one or more POSS compound with said silylated polymer.

All ingredients can be added to the composition in any possible way known by the skilled person, including direct mixing, plasticizers, adhesion promoters, moisture scavengers, fillers, thixotropic agents, UV stabilizers etc. and mixtures thereof.

The materials of the invention are highly suitable, for example, in applications for adhesives, sealants, foams, coatings, elastomers, or encapsulants.

In an embodiment, the composition according to the present invention can be used in adhesives, sealants, coatings, elastomers, encapsulants, flexible foams and rigid or semi-rigid foams.

The present invention encompasses a product comprising a composition according to the present invention. The present invention also encompasses a product, obtained by curing a composition according to the invention. Non-limiting examples of suitable products encompassed by the invention comprises adhesives, sealants, coatings, elastomers, encapsulants, flexible foams, rigid or semi-rigid foams.

In some embodiments, the product may be an adhesive. In some embodiments, the product may be a sealant. In other embodiments, the product may be an elastomer. In yet other embodiments, the product may be a foam, such as a flexible foam or a rigid or semi-rigid foam. In yet other embodiments, the product may be an encapsulant. In yet other embodiments, the product may be a coating.

In some embodiments, the composition comprises a silylated polymer and the product may be a polyurethane product. In some embodiments, the product may be a polyurethane adhesive. In some embodiments, the product may be a polyurethane sealant. In other embodiments, the product may be a polyurethane elastomer. In yet other embodiments, the product may be a polyurethane foam, such as a flexible foam or a rigid or semi-rigid polyurethane foam. In yet other embodiments, the product may be a polyurethane encapsulant. In yet other embodiments, the product may be a polyurethane coating.

In the context of the present invention tin-free means a tin level of below 0.001 wt %.

Unless otherwise indicated, all parts and all percentages in the following examples, as well as throughout the specification, are parts by weight or percentages by weight respectively, except indicated otherwise.

Silylated polymer 1: made from methylenediphenylenediisocyanate (MDI; Suprasec 3050; Huntsman Polyurethanes: a 50/50 mixture of the 2,4- and 4,4-isomers), polypropylene glycol (PPG2000, Daltocel F456, produced by Huntsman) and N-butyl aminopropyl trimethoxysilane (Dynasylan 1189, supplied by Evonik Industries).
Silylated polymer 2—MS polymer from Kaneka Corporation MS polymer, being PPG terminated with methyl dimethoxy silyl group.

Alternatively, commercially available silylated polymers such as SPUR materials from Momentive and/or Polymer ST from Evonik can be used as silylated polymer.

The POSS compound used in the examples is a polyhedral oligomeric metallo silsesquioxane, as described in the examples below, and which can be provided by the firm Hybrid Catalysis.

Surface cure characteristics for examples 1, 2 and comparative example 1 below were studied by BK dryer experiments as described below:

A coating (500 μm thickness) was applied on 305×24.5×2.45 mm³ glass strips. The test samples were placed on a BK dryer recorder under controlled atmosphere of 23° C. and 50% relative humidity. A metal needle in perpendicular contact with the sample was dragged along the glass strip at a fixed speed and curing profiles were recorded.

Surface cure characteristics for examples 3, 4 and comparative example 2 below were studied by BK dryer experiments as described below:

A coating (500 μm thickness) was applied on 305×24.5×2.45 mm³ glass strips. The test samples were placed on a BK dryer recorder under controlled atmosphere of 25° C. and 55% relative humidity. A metal needle in perpendicular contact with the sample was dragged along the glass strip at a fixed speed and curing profiles were recorded.

The points SOT, EOT and ES corresponding to characteristic curing steps are reported for all examples below.

SOT=start opening time, corresponding to the moment where a permanent trace is visible
EOT=end opening time, corresponding to the end of skin ripping but the surface is still not fully cured
ES=end of scratch

### EXAMPLE 1

A solution comprising 99.52 wt % of silylated polymer 1 and 0.48 wt % of POSS compound corresponding to formula I, wherein Z is O-methyl and R₁ to R₇ are each i-octyl is provided. The solution is flushed with nitrogen and mixed at 2500 rpm for 5 min. The final content of POSS compound in the silylated polymer is 0.48 wt % and Ti loading is 0.018 wt %. Castings of 500 μm are made and cure characteristics are studied with BK dryer recorder.

Start open time: 44 min and end of scratch time: 58 min.

### EXAMPLE 2

A solution comprising 99.5 wt % of silylated polymer 1 and 0.5 wt % of POSS compound corresponding to formula I, wherein Z is O-methyl and R₁ to R₇ are randomly selected between i-octyl and i-butyl. The solution is flushed with nitrogen and mixed at 2500 rpm for 5 min. The final content of POSS compound in the silylated polymer is 0.5 wt % (75% in mole of i-octyl and 35% in mole of i-butyl) and Ti loading 0.021 wt %. Castings of 500 μm are made and cure characteristics are studied with BK dryer recorder.

Start open time: 60 min and end of scratch time: 80 min.

### Comparative Example 1

A solution comprising 99.54 wt % of silylated polymer 1 and 0.46 wt % of DBTDL compound is provided. The solution is flushed with nitrogen and mixed at 2500 rpm for 5 min. The final content of DBTDL compound in the silylated polymer is 0.46 wt % and Sn loading is 0.086 wt %. Castings of 500 μm are made and cure characteristics are studied with BK dryer recorder.

Start open time: 60 min and end of scratch time: 71 min.

### EXAMPLE 3

A solution comprising 99.5 wt % of silylated polymer 2 and 0.5 wt % of POSS compound corresponding to formula I, wherein Z is O-methyl and R₁ to R₇ are each i-octyl is provided. The solution is flushed with nitrogen and mixed at 2500 rpm for 5 min. The final content of POSS compound in the silylated polymer is 0.5 wt % and Ti loading is 0.018 wt %. Castings of 500 μm are made and cure characteristics are studied with BK dryer recorder.

Start open time: 4.5 hours.

### EXAMPLE 4

A solution comprising 99.5 wt % of silylated polymer 2 and 0.5 wt % of POSS compound, which is obtained by mixing 75% in mole of a first POSS compound corresponding to formula I, wherein Z is O-methyl and R₁ to R₇ are each i-octyl with 25% in mole of a second POSS compound corresponding to formula I, wherein Z is O-methyl and R₁ to R₇ are each i-butyl. The solution is flushed with nitrogen and mixed at 2500 rpm for 5 min. The final content of POSS compound in the silylated polymer is 0.5 wt % and Ti loading is 0.019 wt %. Castings of 500 μm are made and cure characteristics are studied with BK dryer recorder.

Start open time: 7.75 hours.

### Comparative Example 2

A solution comprising 99.5 wt % of silylated polymer 2 and 0.5 wt % of DBTDL compound is provided. The solution is flushed with nitrogen and mixed at 2500 rpm for 5 min. The final content of DBTDL compound in the silylated polymer is 0.5 wt % and Sn loading is 0.086 wt %. Castings of 500 μm are made and cure characteristics are studied with BK dryer recorder.

Start open time: >24 hours.

Although the invention describes the use of tin-free polyhedral oligomeric titanium silsesquioxane for catalysis of silylated polymers, said tin-free polyhedral oligomeric titanium silsesquioxane can be used to catalyze every compounds carrying at least one Si(OR⁵⁰)ₚR⁵¹₃₋ₚ groups, including low molecular weight materials, which could be silanes; for example, wherein R₅₀ can be selected from H; optionally substituted C₁₋₂₄alkyl; optionally substituted C₃₋₂₄cycloalkyl; optionally substituted C₆₋₂₄aryl; optionally substituted heteroaryl; and wherein R₅₁ can be selected from H; optionally substituted C₁₋₂₄alkyl; optionally substituted C_{3 24}cycloalkyl; optionally substituted C₆₋₂₄aryl; optionally substituted heteroaryl; wherein, p can be 0 or 1. Non-limiting examples of suitable substituents for the alkyl, cycloalkyl, aryl or heteroaryl groups can be selected from, for example, halogen atoms and COOH groups.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

Whenever the term “substituted” is used in the present invention, it is meant to indicate that one or more hydrogens on the atom indicated in the expression using “substituted” is replaced with a selection from the indicated group, provided that the indicated atom's normal valency is not exceeded.

Where groups may be optionally substituted, such groups may be substituted once or more, and preferably once, twice or thrice. Substituents may be selected from but are not limited to, for example, the group comprising alcohol, carboxylic acid, ester, amino, amido, ketone, ether and halide functional groups; such as for example halogen, hydroxyl, oxo, amido, carboxy, amino, haloC₁₋₆ alkoxy, and haloC₁₋₆ alkyl.

As used herein the terms such as “substituted or unsubstituted C₁₋₂₀ alkyl”, “substituted or unsubstituted C₈₋₂₀ cycloalkyl”, “substituted or unsubstituted C₈₋₂₀ alkenyl”, or “substituted or unsubstituted C₈₋₂₀ aryl” are respectively synonymous to C₁₋₂₀ alkyl“, C₈₋₂₀ cycloalkyl”, C₈₋₂₀ alkenyl“, C₈₋₂₀ aryl, each being optionally substituted with . . . ”.

As used herein the terms such as “alkyl, alkenyl, aryl, or cycloalkyl, each being optionally substituted with . . . ” or “alkyl, alkenyl, aryl, or cycloalkyl, optionally substituted with . . . ” encompasses “alkyl optionally substituted with . . . ”, “alkenyl optionally substituted with . . . ”, “aryl optionally substituted with . . . ” and “cycloalkyl optionally substituted with . . . ”.

For instance, the term “C₈₋₂₀ alkyl”, as a group or part of a group, refers to a hydrocarbyl radical of formula CₙH₂ₙ₊₁, wherein n is a number ranging from 8 to 20. Preferably, the alkyl group comprises from 8 to 20 carbon atoms, for example 8 to 15 carbon atoms, for example 8 to 10 carbon atoms, for example 8 to 9 carbon atoms. Alkyl groups may be linear or branched and may be substituted as indicated herein. When a subscript is used herein following a carbon atom, the subscript refers to the number of carbon atoms that the named group may contain. Thus, for example, C₈₋₂₀ alkyl means an alkyl of 8 to 20 carbon atoms. Thus, for example, C8-10 alkyl means an alkyl of 8 to 10 carbon atoms.

The term “C₈₋₂₀ cycloalkyl” as a group or part of a group, refers to a cyclic alkyl group, i.e. a monovalent, saturated, or unsaturated hydrocarbyl group having 1 or 2 cyclic structure. Cycloalkyl includes all saturated hydrocarbon groups containing 1 to 2 rings, including monocyclic or bicyclic groups. Cycloalkyl groups may comprise 8 or more carbon atoms in the ring and generally, according to this invention comprise from 8 to 20, preferably 8 to 15 carbon atoms.

The term “C₈₋₂₀ alkenyl” as a group or part of a group, refers to an unsaturated hydrocarbyl group, which may be linear, or branched, comprising one or more carbon-carbon double bonds. Preferred alkenyl groups thus comprise between 8 and 20 carbon atoms, for example between 8 and 15 carbon atoms, for example between 8 and 10 carbon atoms.

The term “aryl”, as a group or part of a group, refers to a polyunsaturated, aromatic hydrocarbyl group having a single ring (i.e. phenyl) or multiple aromatic rings fused together (e.g. naphthyl) or linked covalently, typically containing 8 to 20 carbon atoms; preferably 8 to 15 carbon atoms, wherein at least one ring is aromatic. The aromatic ring may optionally include one to two additional rings fused thereto. Aryl is also intended to include the partially hydrogenated derivatives of the carbocyclic systems enumerated herein.

1. A liquid composition comprising at least one silylated polymer and at least one tin-free polyhedral oligomeric titanium silsesquioxane in liquid form, which is a compound of formula (I): 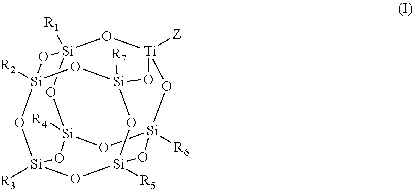
wherein,
Z is —OH or —O—C₁₋₁₀alkyl, preferably —O—C₁₋₄ alkyl, more preferably —O-methyl or —O— ethyl;
wherein R₁, R₂, R₃, R₄, R₅, R₆ and R₇ are independently selected from substituted or unsubstituted C₈₋₂₀ alkyl, substituted or unsubstituted C₈₋₂₀ cycloalkyl, substituted or unsubstituted C₈₋₂₀ alkenyl, or substituted or unsubstituted C₈₋₂₀ aryl;
Or
wherein R₁ to R₇ are each substituted or unsubstituted C₈ alkyl or C₉ alkyl or C₁₀ alkyl or C₁₁ alkyl or C₁₂ alkyl or C₁₃ alkyl or C₁₄ alkyl or C₁₅ alkyl or C₁₆ alkyl or C₁₇ alkyl or C₁₈ alkyl or C₁₉ alkyl or C₂₀ alkyl or combinations thereof;
Or
wherein at least one first radical of R₁ to R₇ is chosen from substituted or unsubstituted C₈₋₂₀ alkyl, substituted or unsubstituted C₈₋₂₀ cycloalkyl, substituted or unsubstituted C₈₋₂₀ alkenyl, or substituted or unsubstituted C₈₋₂₀ aryl, and wherein at least one second radical of R₁ to R₇, different from said at least one first radical, is selected from substituted or unsubstituted C₁₋₇ alkyl, substituted or unsubstituted C₁₋₇ cycloalkyl, substituted or unsubstituted C₁₋₇ alkenyl, or substituted or unsubstituted C₁₋₇ aryl, and wherein the remaining radicals of R₁ to R₇ are independently selected from substituted or unsubstituted C₁₋₇ alkyl, substituted or unsubstituted C₁₋₇ cycloalkyl, substituted or unsubstituted C₁₋₇ alkenyl, or substituted or unsubstituted C₁₋₇ aryl, substituted or unsubstituted C₈₋₂₀ alkyl, substituted or unsubstituted C₈₋₂₀ cycloalkyl, substituted or unsubstituted C₈₋₂₀ alkenyl, or substituted or unsubstituted C₈₋₂₉ Aryl.

2. The composition according to claim 1, wherein at least 2 radicals from R₁ to R₇ are selected from substituted or unsubstituted C₈₋₂₀ alkyl, substituted or unsubstituted C₈₋₂₀ cycloalkyl, substituted or unsubstituted C₈₋₂₀ alkenyl, or substituted or unsubstituted C₈₋₂₀ aryl, and wherein the remaining ones are independently selected from substituted or unsubstituted C₁₋₇ alkyl, substituted or unsubstituted C₁₋₇ cycloalkyl, substituted or unsubstituted C₁₋₇ alkenyl, or substituted or unsubstituted C₁₋₇ aryl.

3. The composition according to claim 1, wherein at least 2 radicals from R₁ to R₇ are each substituted or unsubstituted C₈ alkyl or C₉ alkyl or C₁₀ alkyl or Cu alkyl or C₁₂ alkyl or C₁₃ alkyl or C₁₄ alkyl or C₁₅ alkyl or C₁₆ alkyl or C₁₇ alkyl or C₁₈ alkyl or C₁₉ alkyl or C₂₀ alkyl, and wherein the remaining ones are independently selected from substituted or unsubstituted C₁₋₇ alkyl, substituted or unsubstituted C₁₋₇ cycloalkyl, substituted or unsubstituted C₁₋₇ alkenyl, or substituted or unsubstituted C₁₋₇ aryl.

4. The composition according to claim 1, wherein at least 20% in mole of R₁ to R₇ are individually selected from the list consisting of substituted or unsubstituted C₈₋₂₀ alkyl, preferably C₈₋₁₈ alkyl C₈₋₂₀ cycloalkyl, substituted or unsubstituted C₈₋₂₀ alkenyl, or substituted or unsubstituted C₈₋₂₀ aryl, when Z is OH or O—C₁₋₄ alkyl.

5. The composition according to claim 1, wherein said silylated polymer comprises a silane moiety with at least one radical, when Z is respectively, O-methyl or O-ethyl.

6. The composition according to claim 1, wherein said at least one tin-free polyhedral oligomeric titanium silsesquioxane is in liquid form, in the absence of solvent.

7. The composition according to claim 1, wherein silylated polymer is selected from the group consisting of silylated polyether, silylated silicone and silylated polyurethanes.

8. The composition according to claim 7, wherein said silylated polymer comprises alkoxysilyl or silanol moieties.

9. The composition according to claim 7, wherein said silylated polymer is obtained by reaction of at least one isocyanate with at least one isocyanate reactive compound and with at least one alkoxysilane compound.

10. The composition according to claim 1, wherein the amount of said tin-free polyhedral oligomeric titanium silsesquioxane is ranging from 0.001 wt % to 5 wt % based on total weight of the composition.

11. The composition according to claim 1, wherein said composition contains less than 0.001 wt % of tin.

12. A moisture curable silylated polymer composition obtainable by applying the following steps:
providing at least one silylated polymer as defined according to any one claim 1; and
mixing said at least one silylated polymer with at least one tin-free polyhedral oligomeric titanium silsesquioxane in liquid form as defined according to claim 1.

13. A process for manufacturing a moisture curable silylated polymer composition, which process comprises the following steps:
adding said at least one silylated polymer composition to at least one tin-free polyhedral oligomeric titanium silsesquioxane in liquid form as defined according to claim 1; and
curing said silylated polymer composition.

14. (canceled)
